(19) United States
(12) Patent Application Publication
(10) Pub. No.: US 2009/0083192 A1
(43) Pub. Date: Mar. 26, 2009

(54) CONTRACT FORMATION AND DISPUTE RESOLUTION IN A VIRTUAL WORLD

(76) Inventors: Brian Ronald Bokor, Raleigh, NC (US); Daniel Edward House, Raleigh, NC (US); Andrew Bryan Smith, Morrisville, NC (US); William Bruce Nicol, II, Durham, NC (US)

Correspondence Address: MOORE & VAN ALLEN, PLLC For IBM, P.O. Box 13706, Research Triangle Park, NC, 27709, US

(21) Appl. No.: 11/861,837

(22) Filed: Sep. 26, 2007

(51) Int. Cl. G06Q 99/00; G06Q 20/00

(52) U.S. Cl. 705/80

(57) ABSTRACT

A method for contract formation and dispute resolution in a virtual world may include presenting a graphical user interface to permit formation of a contract. The method may also include permitting a set of contract terms to be defined. The method may further include providing a mechanism for review and acceptance of the set of contract terms and providing a mechanism to designate a contract as complete and to release a bond stored in a virtual contract object for virtual payment to a contractor in response an acceptance that the contract has been fulfilled.

### BACKGROUND OF THE INVENTION

The present invention relates to simulations, virtual world simulations of the real-world or real-life or a virtual world and the like, and more particularly to a system and method for contract formation and dispute resolution in a virtual world.

Computer based simulations are becoming more ubiquitous. Simulations may be used for training purposes, for entertainment or for other purposes. Computer simulations such as Second Life or similar simulations present a virtual world which allows users or players to be represented by characters known as avatars. Second Life is an Internet-based virtual world launched in 2003 by Linden Research, Inc. A downloadable client program called the Second Life Viewer enables users, called “Residents”, to interact with others in the virtual world through motional avatars. The virtual world basically simulates the real world or environment. The users or residents via their avatar can explore the virtual world, meet other users or residents, socialize, participate in individual and group activities, create and trade items (virtual property) and services from one another. The challenge with respect to such simulations or virtual worlds is to make them as realistic or as much like the real-world or real-life as possible. This increases the utility of such simulations as a training tool or enjoyment of the participants or users as an entertainment medium. Second Life is a trademark of Linden Research, Inc. in the United States, other countries or both.

### BRIEF SUMMARY OF THE INVENTION

In accordance with an embodiment of the present invention, a method for contract formation and dispute resolution in a virtual world may include presenting a graphical user interface to permit formation of a contract. The method may also include permitting a set of contract terms to be defined. The method may further include providing a mechanism for review and acceptance of the set of contract terms and providing a mechanism to designate a contract as complete and to release a bond stored in a virtual contract object for virtual payment to a contractor in response an acceptance that the contract has been fulfilled.

In accordance with another embodiment of the present invention, a method for contract formation and dispute resolution in a virtual world may include presenting a graphical user interface to permit formation of a contract and to permit dispute resolution in the virtual world. The method may also include permitting a set of contract terms to be defined and providing a mechanism for review and acceptance of the set of contract terms. The method may additionally include providing a mechanism to designate a contract as complete and to release a bond stored in a virtual contract object for payment to a contractor in response to a contractee accepting that the contract has been fulfilled. The method may further include providing a mechanism to designate the contract as being in dispute in response to the contractee not accepting that the contact has been fulfilled.

In accordance with another embodiment of the present invention, a method for contract formation and dispute resolution in a virtual world may include presenting a graphical user interface to permit formation of a contract and to permit dispute resolution in the virtual world. The method may also include permitting a set of contract terms to be defined and providing a mechanism for review and acceptance of the set of contract terms. The method may also preventing the contract terms from changed in response to the contract being accepted by a contractee and acquiring a bond from the contractee in response to the contract being accepted by the contractee. The bond may be stored in association with a virtual contract object for payment to the contractor in response to acceptance by the contractee that the contract has been fulfilled. The method may additionally include notifying the contractor of acceptance of the contract and receipt of the bond. The method may further include providing a mechanism to designate the contract as being complete and to release the bond stored in the virtual contract object for payment to the contractor in response to the contractee accepting that the contract has been fulfilled. The method may still further include providing a mechanism to designate the contract as being in dispute in response to the contractee not accepting that the contact has been fulfilled.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block schematic diagram of an example of a system for contract formation and dispute resolution in a virtual world in accordance with an embodiment of the present invention.

FIG. 2 is a flow chart of an example of a method for forming a contract in a virtual world in accordance with an embodiment of the present invention.

FIG. 3 is a flow chart of an example of a method for delivery and acceptance for fulfillment of a contract in a virtual world in accordance with an embodiment of the present invention.

FIG. 4 is a flow chart of an example of a method for dispute resolution in a virtual world in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, pigeon, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

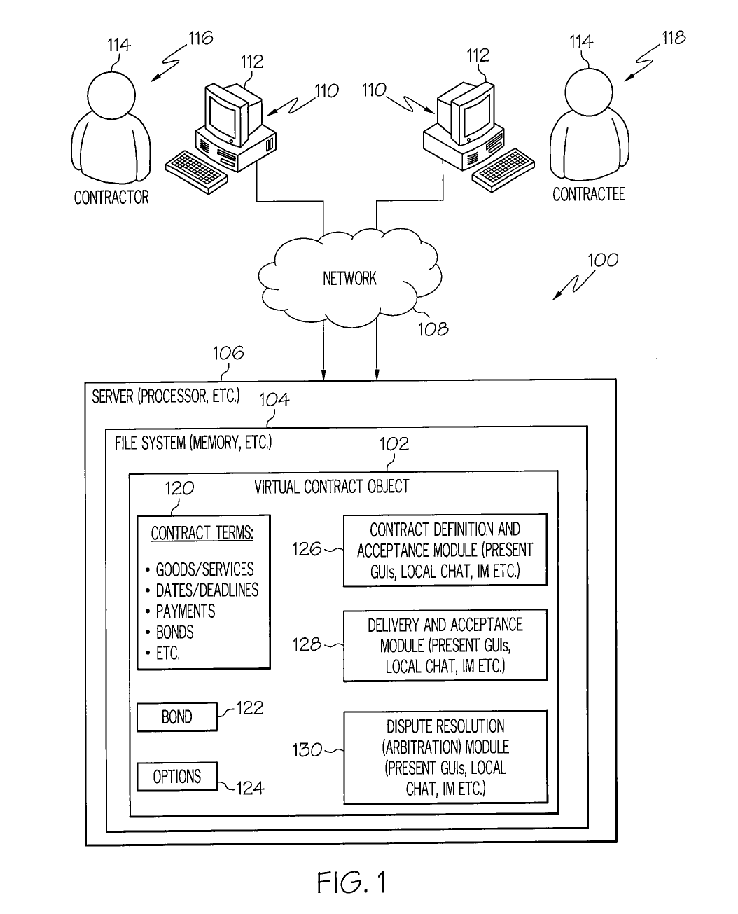

FIG. 1 is a block schematic diagram of an example of a system 100 for contract formation and enforcement in a virtual world in accordance with an embodiment of the present invention. The system 100 may include a virtual contract object 102. The virtual contract object 102 may present one or more predetermined graphical user interfaces to permit formation of a contract for virtual goods or services in a virtual world or simulation and to permit enforcement or resolution of any disputes that may arise related to the contract. The virtual contract object 102 may be part of a virtual world simulation system or program, such as Second Life or similar virtual world.

The virtual contact object 102 may also be a self contained system with embedded logic, decision making, state based operations and other functions that may operate in conjunction with a virtual world simulation, such as Second Life. The self contained system may allow businesses and individuals in the virtual world to operate across borders and legal systems. Virtual Worlds allow for legal or jurisdictional boundaries to be crossed much more easily. One embodiment of the present invention provides a system for working across legal or jurisdictional boundaries, cultural boundaries or the like, and dealing with any Government or legal issues that might be encountered in the real-world and can be created or simulated in the virtual world contract. For instance, someone in the United States building some virtual items, goods or objects for someone in China. An embodiment of the invention can provide a lightweight programmatic solution that can deal with formation of contacts dealing with any legal or Government entities, any legal boundary issues, international issues or similar issues.

The virtual contract object 102 may be stored on a file system 104 or memory of a server 106. The virtual contract object 102 may be accessed by users or participants via a network 108 using an Internet browser on a personal computer 110 or by similar means. The network 108 may be the Internet, a private network or other network. The predetermined GUIs that may be generated by the virtual contract object 102 as described herein may be presented on a display 112 of the personal computer 110 to a user 114. As described herein, a user 114 who defines a contract for virtual goods or services may be defined as a contractor 116 and a user 114 that accepts the contract for the virtual goods and services may be defined as a contractee 118.

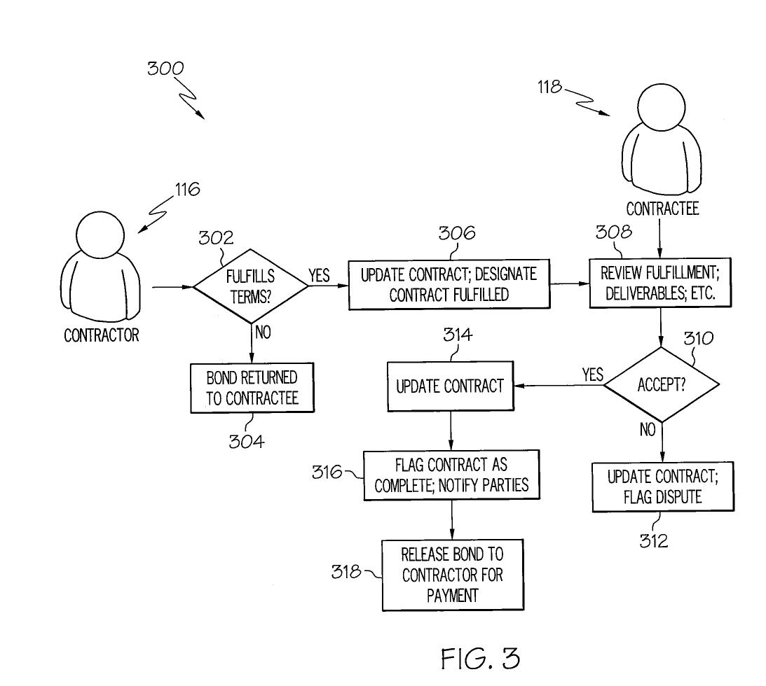

The virtual contract object 102 may include contract terms 120. The contract terms 120 may be defined by the contractor 116. Examples of the contract terms may include an identification or description of the virtual goods or services to be offered; dates and deadlines, such as when the virtual goods or services will be offered, deadline for completion of the services, etc.; payments or costs for the goods or services; amount of a bond 122 that must be applied or stored in the virtual contract object 102 for payment by the contractee 118 upon fulfillment of the contract and acceptance by the contractee 118 as described herein; and any other terms that may be pertinent to a particular virtual transaction or contract. An example of a method for delivery of any deliverables and acceptance for fulfillment of the contract in the virtual world will be described with reference to FIG. 3.

The virtual contract object 102 may also include options 124. The options feature 124 may include any future enhancements, configurations, and extensions to the existing system or any additions relating to the virtual contract object 102. As an example a notification system could be added to the virtual contract object 102 which could be configured as an option to email updates or provide notification by some other mechanism.

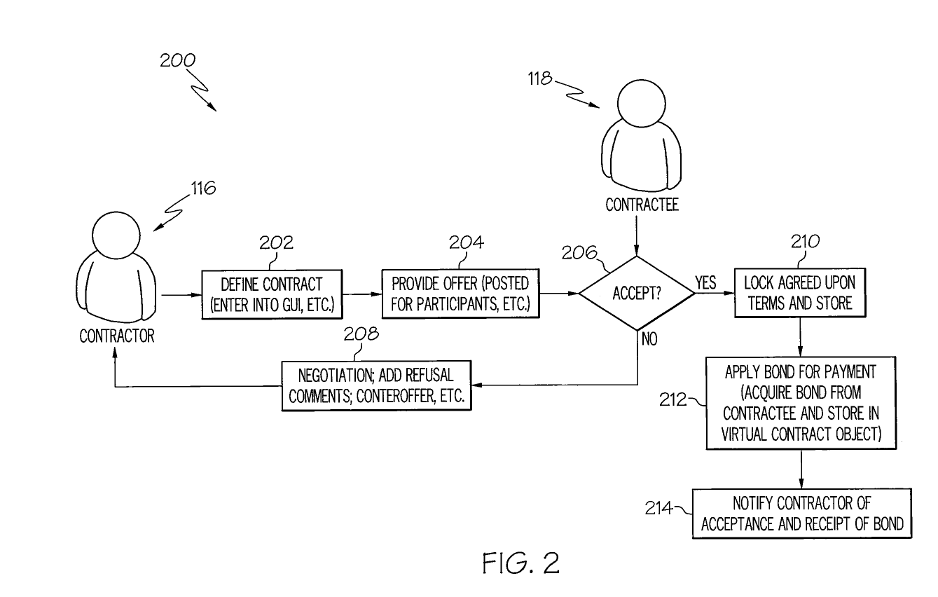

The virtual contract object 102 may also include a contract definition and acceptance module 126. An example of a method that may be embodied in the contract definition and acceptance module 126 will be described with reference to FIG. 2. The contract definition and acceptance module 126 may present GUIs to the contractor to permit the contractor to define the contract terms 120. Internet communications technologies or applications, such as Local Chat, Instant Messaging, e-mail, or similar communications means, may be used to permit defining the contract, negotiation of the contract between the contractor 116 and the contractee 118, and acceptance of the contract by the contractee 118.

The virtual contract object 102 may also include a delivery and acceptance module 128. The delivery and acceptance module 128 may permit the contractor 116 to designate that the contract terms have been fulfilled. The delivery and acceptance module 128 may also permit the contractee 118 to review any virtual deliverables or fulfillment of the contract terms and to acceptance of the contract as being fulfilled or completed. The delivery and acceptance module 128 may present GUIs for the contractor 116 to designate that the contract terms have been fulfilled and to permit review and acceptance by the contractee 118. Internet communications means similar to those previously described may also be utilized by the delivery and acceptance module 128 to permit communications between the contractor 116 and the contractee 118. An example of a method that may be embodied in the delivery and acceptance module 128 will be described with reference to FIG. 3.

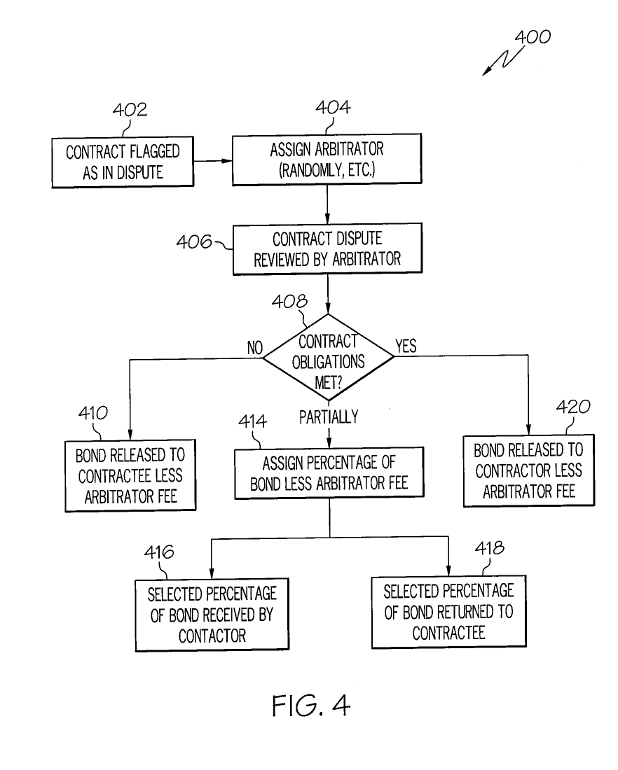

The virtual contract object 102 may further include a dispute resolution or arbitration module 130. The dispute resolution module 130 provides a mechanism for resolution of any contract disputes between the contractor 116 and contractee 118. For example, in response to the contractee 118 not accepting that the contract has been fulfilled or completed, the contract may be designated or flagged as being in dispute. An arbitrator or panel of arbitrators may review the contract dispute and select an appropriate resolution. The dispute resolution module 130 may present appropriate GUIs to the contractor 116, contractee 118 and arbitrator in addition to utilization of other known Internet communications technologies to facilitate the resolution of any dispute. An example of a method that may be embodied in the dispute resolution module 130 will be described with reference to FIG. 4.

FIG. 2 is a flow chart of an example of a method 200 for forming a contract in a virtual world in accordance with an embodiment of the present invention. The method 200 may be embodied in the contract definition and acceptance module 126 of FIG. 1.

In block 202, a contract may be defined by the contractor 116. One or more predetermined GUIs may be presented to the contractor 116 for the contractor to enter contract terms 120 (FIG. 1) to define the contract. In block 204, the offer may be communicated to the other users, participants or residents in the virtual world. The virtual world may include a bulletin board, virtual newspaper, or other means to post or present the contractor's offer.

In block 206 a potential contractee 118 may accept or refuse the offer. If the contractee refuses the offer in block 206, the method 200 may advance to block 208. In block 208, the offer may be negotiated between the contractor 116 and contractee 118 using any of the known Internet communications means previously described. The contractee 118 may add comments to the refusal. The contractee 118 may make a counteroffer or other proposal. The contractor 116 may then revise the offer and present it to the contractee 118, or reject the counteroffer and wait for acceptance by another contractee 118.

If the contractee 118 accepts the offer in block 206, the method 200 may advance to block 210. In block 210, the agreed upon terms of the contract may be locked. That is, the contract terms cannot be changed by the contractor 116 or contractee 118 after the contractee 118 has accepting the offer. The locked contract terms 120 may then be stored in the virtual contract object 102.

In block 212, a bond 122 (FIG. 1) may be applied for payment upon fulfillment of the contract terms and acceptance of fulfillment of the contract terms by the contractee 118 and completion of the contract. The bond 122 represents virtual money in the virtual world. The bond 122 is acquired from the contractee 118 and may be stored in the virtual contract object 102.

In block 214, the contractor 116 may be notified that the contractee 118 has accepted the contract and that the bond has been received and stored in the virtual contract object 102 similar to an escrow arrangement. The contractor 116 may then proceed with fulfillment of the contract terms 120 and providing any virtual goods or services as defined in the contract terms 120.

FIG. 3 is a flow chart of an example of a method 300 for delivery and acceptance for fulfillment of a contract in a virtual world in accordance with an embodiment of the present invention. The method 300 may be embodied in the delivery and acceptance module 128 in FIG. 1.

In block 302, a determination may be made if the contract terms have been fulfilled. If a determination is made in block 302 that the contract terms have not been fulfilled, the bond 122 is returned to the contractee 118 in block 304. If a determination is made in block 302 that the contract terms have been fulfilled, the method 300 may advance to block 306. Determining that the contract terms have been fulfilled in block 302 may involve the contractor 116 entering an indication in a GUI or by other means that the contractor 116 considers the contract terms to be fulfilled.

In block 306, the contract may be updated or the virtual contract object 102 may be updated to designate that the contractor 116 considers the contract terms to have been fulfilled. In block 308, the contractee 118 may review whether the contract terms have been fulfilled to his satisfaction. Any deliverables may be reviewed, such as for example, a virtual object or item that the contractor 116 may have created or constructed for the contractee 118 pursuant to the contract.

In block 310, a determination may be made whether the contractee 118 accepted that the contract terms have been fulfilled or completed. If the contractee 118 did not accept the contract terms as being fulfilled, the method 312 may advance to block 312. In block 312 the contract or virtual contract object 102 may be updated to indicate that the contract is in dispute.

If the contractee 118 accepts the contract terms as being fulfilled in block 310, the method 300 may advance to block 314. In block 314, the contract or virtual contract object may be updated. In block 316, the contract may be flagged or designated as being complete. In block 318, the bond 122 (FIG. 1) may be released to the contractor 116 for payment.

FIG. 4 is a flow chart of an example of a method 400 for dispute resolution in a virtual world in accordance with an embodiment of the present invention. The method 400 may be embodied in the dispute resolution module 130 in FIG. 1.

In block 402, a contract may be flagged as being in dispute. This may be as a result of the contractee 118 not accepting that the contract terms have been fulfilled as described with respect to block 312 in FIG. 3.

In block 404, an arbitrator may be assigned. An arbitrator may be another user or resident that has agreed to serve as an arbitrator in reviewing contract disputes in the virtual world. The arbitrator may be selected randomly from a list or pool of arbitrators or the arbitrator may be assigned sequentially from the list for each subsequent contract dispute. A user may be invited by the virtual world system to become an arbitrator when the user logs on the system. A GUI or dialog box may be presented to the user in response to logging on which may ask the user if he would like to be an arbitrator. If the user responds affirmatively, the user will be added to the list or pool of arbitrators.

The virtual world system could advertise for arbitrators in other ways, but to more quickly get the arbitration feature operational, random users could be automatically invited to be arbitrators when they log on if there is not already a pool of arbitrators currently logged on in the virtual world. Users may be encouraged to be arbitrators by providing that arbitrators are paid a predetermined fee for each dispute they resolve.

Arbitrators may be required to take instruction or a brief online class about the arbitration procedure and to electronically certify or promise to be fair in resolving disputes to the best of their ability. The virtual world system or virtual contract object 102 may track arbitrator fairness. One example of a scalable and automatic way to track fairness may be to track the percentage of dispute resolutions that are appealed. An appeal process may involve referring the contract dispute to a panel of arbitrators.

Arbitrators may also be encouraged to be fair and to provide resolutions that make both parties “feel good” by paying a higher arbitration fee to those arbitrators that have a lower appeal percentage. The higher arbitration fee may be an extra fee over and above a normal, preset fee that may be paid from the bond. The extra fee may be absorbed or paid by the virtual world operator or entity that is sponsoring the virtual world system. The system operator has an interest in having fair arbitrators because this will encourage more users to participate in the system operator's virtual world.

Returning to FIG. 4, in block 406, the contract dispute may be reviewed by the arbitrator. The contract dispute may be presented to the arbitrator in a GUI. The contractee 118 and contractor 116 may each be permitted to submit a brief statement of their position and the relevant facts.

In block 408, the arbitrator may determine the extent to which the contract terms or obligations may have been met. The dispute resolution module 130 may include a mechanism to present a GUI to the arbitrator to review the contract dispute and select one of a plurality of resolutions. If the arbitrator determined that the contract obligations have not been met, the bond may be released to the contractee 118 in block 410. The bond may be reduced by the amount of the arbitrator's fee similar to that previously discussed.

If the arbitrator determines that the contract obligations have been partially met, the arbitrator may assign a selective percentage of the bond to be paid to each of the parties, as indicated in blocks 416 and 418. The selected percentage of the bond may be reduced by the amount of the arbitrator's fee. The arbitrator's fee may be paid by evenly reducing the percentage of each of the parties or may be paid by an unequal reduction of the percentage due each party depending upon the circumstances and the arbitrator's discretion.

If the arbitrator determines that the contract obligations have been met in block 420, the bond may be released to the contractor in block 420. Again, the bond paid may be reduced by the amount of the arbitrator's fee.

In accordance with another embodiment of the present invention, each party may be required to submit a deposit or bond equivalent to the arbitrator's fee in response to a contract dispute. The losing party may then be required to forfeit the bond to satisfy the arbitrator's fee.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for contract formation and dispute resolution in a virtual world, comprising:
presenting a graphical user interface to permit formation of a contract;
permitting a set of contract terms to be defined;
providing a mechanism for review and acceptance of the set of contract terms; and
providing a mechanism to designate the contract as being complete and to release a bond stored in a virtual contract object for virtual payment to a contractor in response an acceptance that the contract has been fulfilled.

2. The method of claim 1, further comprising presenting an offer for acceptance by a contractee to form the contract.

3. The method of claim 1, further comprising providing an interface to permit negotiation of the set of contract terms.

4. The method of claim 1, further comprising preventing the contract terms from being changed in response to the contract being accepted by a contractee.

5. The method of claim 4, further comprising:
acquiring the bond from the contractee in response to the contract being accepted by the contractee;
storing the bond in association with the virtual contract object for payment to the contractor in response to acceptance by the contractee that the contract has been fulfilled; and
notifying the contractor of acceptance of the contract and receipt of the bond.

6. The method of claim 1, further comprising returning the bond to the contractee in response to the contractor failing to fulfill the terms of the contract.

7. The method of claim 1, further comprising providing a mechanism to designate the contract as being in dispute in response to a contractee not accepting that the contact has been fulfilled.

8. The method of claim 1, further comprising:
designating a contract as being in dispute in response to a contractee not accepting that the contract has been fulfilled;
assigning an arbitrator to review the contract dispute; and
presenting a GUI to the arbitrator to permit the arbitrator to review the contract dispute and to select one of a plurality of resolutions.

9. The method of claim 8, further comprising presenting the plurality of resolutions for selection by the arbitrator, wherein presenting the plurality of resolutions comprises:
presenting a first resolution that no contract terms have been fulfilled and a bond is releasable back to the contractee less a fee sent to the arbitrator;
presenting a second resolution that contract terms have been partially fulfilled and a first selected percentage of the bond is releasable to the contractor and a second selected percentage of the bond is returnable to the contractee less a fee sent to the arbitrator; and
presenting a third resolution that all contract terms have been fulfilled and the bond is releasable to the contractor less a fee sent to the arbitrator.

10. A method for contract formation and dispute resolution in a virtual world, comprising:
presenting a graphical user interface to permit formation of a contract and to permit dispute resolution in the virtual world;
permitting a set of contract terms to be defined;
providing a mechanism for review and acceptance of the set of contract terms;
providing a mechanism to designate the contract as complete and to release a bond stored in a virtual contract object for payment to a contractor in response to a contractee accepting that the contract has been fulfilled; and
providing a mechanism to designate the contract as being in dispute in response to the contractee not accepting that the contact has been fulfilled.

11. The method of claim 10, further comprising providing an interface to permit negotiation of the set of contract terms between the contractor and the contractee.

12. The method of claim 10, further comprising locking the contract in response to the contract being accepted by the contractee to prevent the contract terms from being changed after acceptance by the contractee.

13. The method of claim 12, further comprising:
acquiring the bond from the contractee in response to the contract being accepted by the contractee; and
storing the bond in association with the virtual contract object for payment to the contractor in response to acceptance by the contractee that the contract has been fulfilled.

14. The method of claim 10, further comprising:
designating the contract as being in dispute in response to the contractee not accepting that the contract has been fulfilled; and
providing a dispute resolution module to permit resolution of any disputes between the contractee and the contractor in response to the contractee not accepting that the contract has been fulfilled.

15. The method of claim 14, further comprising presenting a GUI to an arbitrator to permit the arbitrator to review a contract dispute and to select one of a plurality of resolutions.

16. A method for contract formation and dispute resolution in a virtual world, comprising:
presenting a graphical user interface to permit formation of a contract and to permit dispute resolution in the virtual world;
permitting a set of contract terms to be defined;
providing a mechanism for review and acceptance of the set of contract terms;
preventing the contract terms from being changed in response to the contract being accepted by a contractee;
acquiring a bond from the contractee in response to the contract being accepted by the contractee;
storing the bond in association with a virtual contract object for payment to the contractor in response to acceptance by the contractee that the contract has been fulfilled;
notifying the contractor of acceptance of the contract and receipt of the bond;
providing a mechanism to designate a contract as complete and to release the bond stored in the virtual contract object for payment to a contractor in response to the contractee accepting that the contract has been fulfilled; and
providing a mechanism to designate the contract as being in dispute in response to the contractee not accepting that the contact has been fulfilled.

17. The method of claim 16, further comprising providing an interface to permit negotiation of the set of contract terms.

18. The method of claim 16, further comprising:
assigning an arbitrator to review the contract dispute in response to the contractee not accepting that the contract has been fulfilled; and
presenting a GUI to the arbitrator to permit the arbitrator to review the contract dispute and to select one of a plurality of resolutions.

19. The method of claim 18, further comprising presenting the plurality of resolutions for selection by the arbitrator, wherein presenting the plurality of resolutions comprises:
presenting a first resolution that no contract terms have been fulfilled and a bond is releasable back to the contractee less a fee sent to the arbitrator;
presenting a second resolution that contract terms have been partially fulfilled and a first selected percentage of the bond is releasable to the contractor and a second selected percentage of the bond is returnable to the contractee less a fee sent to the arbitrator; and
presenting a third resolution that all contract terms have been fulfilled and the bond is releasable to the contractor less a fee sent to the arbitrator.

20. The method of claim 18, wherein assigning the arbitrator comprises assigning the arbitrator randomly or in a predetermined order.
